(19) United States
(12) Patent Application Publication
(10) Pub. No.: US 2022/0050242 A1
(43) Pub. Date: Feb. 17, 2022

(54) ORGANOSILICATE FILMS TO INHIBIT GLASS WEATHERING

(71) Applicant: CORNING INCORPORATED, CORNING, NY (US)

(72) Inventors: Joy Banerjee, Horseheads, NY (US); Jiangwei Feng, Painted Post, NY (US); Wageesha Senaratne, Horseheads, NY (US)

(21) Appl. No.: 17/293,233

(22) PCT Filed: Nov. 6, 2019
(86) PCT No.: PCT/US2019/059963

§ 371 Date: May 12, 2021

Related U.S. Application Data
(60) Provisional application No. 62/769,661, filed on Nov. 20, 2018.

(51) Int. Cl. F21V 8/00; C03C 3/093; C03C 17/30

(52) U.S. Cl. CPC G02B 6/0065; C03C 3/093; C03C 17/30; C03C 2217/78; C03C 2218/111; C03C 2218/116; C03C 2218/1525; C03C 2218/112

(57) ABSTRACT

A light guide plate that includes a glass substrate including an edge surface and at least two major surfaces defining a thickness and an edge surface configured to receive light from a light source and the glass substrate configured to distribute the light from the light source; and an organosilicate film disposed on one of the at least two major surfaces. Display products and methods of processing a glass substrate for use as a light guide plate are also provided.

### CROSS-REFERENCE TO RELATED APPLICATION

This application claims the benefit of priority under 35 U.S.C. § 119 of U.S. Provisional Application Ser. No. 62/769,661 filed on Nov. 20, 2018, the content of which is relied upon and incorporated herein by reference in its entirety.

### FIELD

The disclosure relates to a glass substrate with an organosilicate film disposed on a major surface of the glass substrate that can be used, for example, in displays comprising a light guide plate, in which the light guide plate exhibits reduced weathering affects.

### BACKGROUND

Conventional components used to produce diffused light have included diffusive structures, including polymer light guides and diffusive films which have been employed in a number of applications in the display industry. These applications include bezel-free television systems, liquid crystal displays (LCDs), electrophoretic displays (EPD), organic light emitting diode displays (OLEDs), plasma display panels (PDPs), micro-electromechanical structures (MEMS) displays, electronic reader (e-reader) devices, and others.

Light guide plates (LGPs) are engineered components in display products such as televisions. With the natural transmission-based loss of light from the injection point via LEDs through the optical path length of the television, additional light extraction features are printed on the LGP (typically polymeric ink with dispersed SiO₂ or TiO₂ particles). These additional pattern features facilitate the desired panel brightness profile via extraction of light throughout the LGPs in edge-lit LED TV modules by breaking total internal reflection (TIR) within the LGP.

Although plastic materials can provide adequate properties such as light transmission, these materials exhibit relatively poor mechanical properties such as rigidity, coefficient of thermal expansion (CTE) and moisture absorption. High-transmission glasses, such as the Iris™ family of glasses commercially available from Corning Incorporated, have been employed as light guide plates (LGPs), which can replace polymer LGPs and provide superior mechanical properties. Indeed, such glass substrates can provide improved rigidity, coefficient of thermal expansion and moisture absorption over poly(methyl methacrylate) (“PMMA”) and silyl-modified polyether (“MS”) counterparts.

When alkali-containing glass substrates are used as LGPs, it has been found that particulates formed on the glass surface upon aging under accelerated conditions (e.g., 60° C. and 90% RH) behave as extraneous light extraction features (LEFs). These particles, called “weathering products” or “white spots,” may create an inhomogeneous brightness profile over time across the panel. For example, brightness measurements of a television panel that has been aged compared to an unaged television panel, specific regions that contain weathering products can exhibit increased brightness (measured in units of lumens or nits) in specific regions of the television panel. The effects of weathering products in some regions causes other regions further from the LED on the same television panel to exhibit decreased brightness after weathering, as compared to an unaged television panel.

When weathering occurs uniformly over the LGP, more light extraction occurs at the LED side (i.e., bottom) of the LGP, and as a result, less light is available to be extracted at the top of the LGP, changing the brightness profile so that the bottom of the LGP is brighter and the top of the LGP is dimmer.

Weathering products cannot be removed after a product containing the light guide plate has been assembled. Thus, weathering products can impact light transmission properties of the glass by scattering and light coupling through the glass panel due to additional light leakage. While it would be ideal if the luminance of the light guide plate did not change due to weathering (i.e., the difference in brightness of an aged vs. unaged LGP would ideally be zero), in practice, LGPs can tolerate a certain level of luminance change within customer specifications (e.g., 80-90% brightness uniformity after accelerated aging-based reliability tests). Nevertheless, LGPs comprised of glass substrates may exceed these tolerances, particularly when they are maintained in elevated temperature and/or elevated humidity environments.

Accordingly, there remains a need for glass substrates for use as a light guide plates that exhibit reduced effects from weathering, particularly when the glass substrate is exposed to elevated temperatures and humidity environments.

### SUMMARY

One aspect of the present disclosure provides a light guide plate comprising a glass substrate including an edge surface and at least two major surfaces defining a thickness and an edge surface configured to receive light from a light source and the glass substrate configured to distribute the light from the light source, and an organosilicate film disposed on one of the at least two major surfaces. In certain embodiments, the organosilicate film reduces the formation of white spots upon aging at, for example, 60° C. and 90% relative humidity for 960 hours compared to a light guide plate that does not comprise an organosilicate film.

A second aspect of the present disclosure provides a method of processing a glass substrate for use as a light guide plate, the method comprising providing a glass substrate comprising an edge surface and at least two major surfaces defining a thickness and an edge, forming an organosilicate film on at least one of the at least two major surfaces, wherein weathering-based, non-uniformity in brightness in the light guide plate arising from formation of alkali salts on the major surface with the formed organosilicate film is reduced, compared to a glass substrate that does not comprise the organosilicate film.

A third aspect of the present disclosure provides a display product comprising a light source, a reflector, and a light guide plate disclosed herein. In certain embodiments, the light source is a light emitting diode (LED) optically coupled to the edge surface of the glass substrate.

### BRIEF DESCRIPTION OF THE DRAWINGS

The following detailed description can be further understood when read in conjunction with the following drawings.

FIG. 1 is a cross-sectional view of an exemplary LCD display device;

FIG. 2 is a top view of an exemplary light guide plate;

FIG. 3 illustrates a light guide plate according to certain embodiments of the disclosure;

FIG. 4 depicts a LGP assembly utilized in the Examples to test the luminance of unmodified glass substrates and glass substrates with an organosilicate film disposed on a major surface, after being in elevated temperature and humidity environment;

FIG. 5 is a visual representation of the change in extraneous light extraction for untreated glass substrate when exposed to elevated temperatures and humidity based on the assembly disclosed in FIG. 1;

FIG. 6 is a visual representation of the change in extraneous light extraction in view of any weathering products formed on an aged glass substrate that is provided with an organosilicate film via APCVD, as compared to an unaged glass substrate provided with the same organosilicate film;

FIG. 7 graphically depicts the change in luminance of unmodified glass substrate (control) and for aged glass substrates including an organosilicate film via APCVD upon weathering at 60° C. and 90% relative humidity between 96 and 960 hours;

FIG. 8 graphically depicts the percent coverage of weathering products on unmodified glass substrate (control) and on aged glass substrates with an organosilicate film via APCVD upon weathering at 60° C. and 90% relative humidity between 96 and 960 hours;

FIG. 9 is a visual representation of the change in extraneous light extraction in view of any weathering products formed on an aged glass substrate with an organosilicate film via the application of 30 wt % methyl silsesquioxane (Honeywell Accuglass® 512B Spin-On Glass) in isopropyl alcohol spun onto the glass, as compared to an unaged glass substrate with the same organosilicate film;

FIG. 10 graphically depicts the change in luminance of unmodified glass substrate (control) and for aged glass substrates with an organosilicate film via spun on 30 wt % methyl silsesquioxane (Honeywell Accuglass® 512B Spin-On Glass) in isopropyl alcohol, upon weathering at 60° C. and 90% relative humidity between 96 and 960 hours; and

FIG. 11 graphically depicts the percent coverage of weathering products on unmodified glass substrate (control) and on aged glass substrates with an organosilicate film via spun on 30 wt % methyl silsesquioxane (Honeywell Accuglass® 512B Spin-On Glass) in isopropyl alcohol, upon weathering at 60° C. and 90% relative humidity between 96 and 960 hours.

### DETAILED DESCRIPTION

Embodiments of the disclosure provide a method of processing a glass substrate, for example, a glass substrate configured for use in a display device, and in some embodiments, a glass substrate configured to be used as a light guide plate.

In one or more embodiments, light guide plates comprising glass substrates which include an organosilicate film disposed thereon, exhibit reduced weathering-based, non-uniformity in brightness in the light guide plate arising from formation of scattering features comprised of alkali salts (e.g., sodium salts) or alkaline earth salts (e.g., magnesium or calcium salts), compared to control glass substrates that have not been treated in accordance with the present disclosure (e.g., glass substrates that do not include an organosilicate film). The reduced effects of such weathering can be determined by, for example, one or more of observing an effective reduction of white spot formation on treated glass substrate and/or a reduction of the magnitude of a luminance increase when the glass substrate is aged, for example, at 60° C. and at 90% relative humidity for 960 hours, when compared to an untreated substrate aged under the same conditions. As would be understood in the art, other high temperature and/or high humidity environments can be applied to simulate (or accelerate) “aging” or “weathering” in high temperature and/or high humidity environments.

While the present disclosure is not limited to a particular theory, some glass substrates contain many single valence species, such as Na, at the glass surface and bulk. Alkali ions (e.g., Na⁺) within the surface layer are extracted via ion-exchange with water (from nanoscale adsorbed layer on the glass at elevated humidity) after which the alkali ions can react with gaseous species such as CO₂ in the environment to form precipitates (less than a micrometer in size) that can either nucleate and grow during the weathering process (visually observed as “white spots”). Kinetics of nucleation and growth of precipitates are accelerated in a humid chamber (e.g., at 60° C. and 90% relative humidity), and these precipitates (weathering products or “white spots”) have been chemically identified as alkali salts and result in added scattering (an increase in luminance). While again not being bound by any particular theory, the organosilicate film reduces the formation of weathering products that would otherwise occur due to moisture-mediated out-diffusion of alkali ions over time.

In one or more embodiments, a glass substrate has any desired size and/or shape as appropriate to produce a desired light distribution. The glass substrate comprises a first major surface that emits light and a second major surface opposite the first major surface. In some embodiments, the first and second major surfaces are planar or substantially planar, e.g., substantially flat. The first and second major surfaces of various embodiments are parallel or substantially parallel. The glass substrate of some embodiments includes four edges, or may comprise more than four edges, e.g. a multi-sided polygon. In other embodiments, the glass substrate comprises less than four edges, e.g., a triangle. The light guide plate of various embodiments comprises a rectangular, square, or rhomboid sheet having four edges, although other shapes and configurations can be employed.

The glass substrate comprises any material known in the art for use in display devices. In exemplary embodiments, the glass substrate comprises aluminosilicate, alkali-aluminosilicate, borosilicate, alkali-borosilicate, aluminoborosilicate, alkali-aluminoborosilicate, soda-lime, or other suitable glasses. In one embodiment, the glass is selected from an aluminosilicate glass, a borosilicate glass and a soda-lime glass. Examples of commercially available glasses suitable for use as a glass light guide plate include, but are not limited to, Iris™ and Gorilla® glasses from Corning Incorporated.

In one or more embodiments, the glass substrate comprises, in mol %, ranges of the following oxides:

### 50-90 mol % SiO₂,

0-20 mol % Al₂O₃,
0-20 mol % B₂O₃, and
0-25 mol % RₓO, wherein x is 2 and R is chosen from Li, Na, K, Rb, Cs, and combinations thereof, or wherein x is 1 and R is chosen from Zn, Mg, Ca, Sr, Ba, and combinations thereof, and wherein the glass substrate comprises 0.5-20 mol % of one oxide selected from Li₂O, Na₂O, K₂O and MgO. In one or more embodiments, the glass substrate comprises on a mol % oxide basis at least 3.5-20 mol %, 5-20 mol %, 10-20 mol % of one oxide selected from Li₂O, Na₂O, K₂O and MgO.

In one or more embodiments, the glass substrate comprises an aluminosilicate glass comprising at least one oxide selected from alkali oxides such as Li₂O, Na₂O, K₂O and alkaline earth oxides, e.g., CaO and MgO, rendering the glass substrate susceptible to weathering products upon exposure to aging conditions described herein. In one or more embodiments, the glass substrate comprises, in mol %, ranges of the following oxides:

SiO₂: from about 65 mol % to about 85 mol %;
Al₂O₃: from about 0 mol % to about 13 mol %;
B₂O₃: from about 0 mol % to about 12 mol %;
Li₂O: from about 0 mol % to about 2 mol %;
Na₂O: from about 0 mol % to about 14 mol %;
K₂O: from about 0 mol % to about 12 mol %;
ZnO: from about 0 mol % to about 4 mol %;
MgO: from about 0 mol % to about 12 mol %;
CaO: from about 0 mol % to about 5 mol %;
SrO: from about 0 mol % to about 7 mol %;
BaO: from about 0 mol % to about 5 mol %; and
SnO₂: from about 0.01 mol % to about 1 mol %.

In one or more embodiments, the glass substrate comprises, in mol %, ranges of the following oxides:

SiO₂: from about 70 mol % to about 85 mol %;
Al₂O₃: from about 0 mol % to about 5 mol %;
B₂O₃: from about 0 mol % to about 5 mol %;
Li₂O: from about 0 mol % to about 2 mol %;
Na₂O: from about 0 mol % to about 10 mol %;
K₂O: from about 0 mol % to about 12 mol %;
ZnO: from about 0 mol % to about 4 mol %;
MgO: from about 3 mol % to about 12 mol %;
CaO: from about 0 mol % to about 5 mol %;
SrO: from about 0 mol % to about 3 mol %;
BaO: from about 0 mol % to about 3 mol %; and
SnO₂: from about 0.01 mol % to about 0.5 mol %.

In one or more embodiments, the glass substrate comprises, in mol %, ranges of the following oxides:

SiO₂: from about 72 mol % to about 82 mol %;
Al₂O₃: from about 0 mol % to about 4.8 mol %;
B₂O₃: from about 0 mol % to about 2.8 mol %;
Li₂O: from about 0 mol % to about 2 mol %;
Na₂O: from about 0 mol % to about 9.3 mol %;
K₂O: from about 0 mol % to about 10.6 mol %;
ZnO: from about 0 mol % to about 2.9 mol %;
MgO: from about 3.1 mol % to about 10.6 mol %;
CaO: from about 0 mol % to about 4.8 mol %;
SrO: from about 0 mol % to about 1.6 mol %;
BaO: from about 0 mol % to about 3 mol %; and
SnO₂: from about 0.01 mol % to about 0.15 mol %.

In one or more embodiments, the glass substrate comprises, in mol %, ranges of the following oxides:

SiO₂: from about 80 mol % to about 85 mol %;
Al₂O₃: from about 0 mol % to about 0.5 mol %;
B₂O₃: from about 0 mol % to about 0.5 mol %;
Li₂O: from about 0 mol % to about 2 mol %;
Na₂O: from about 0 mol % to about 0.5 mol %;
K₂O: from about 8 mol % to about 11 mol %;
ZnO: from about 0.01 mol % to about 4 mol %;
MgO: from about 6 mol % to about 10 mol %;
CaO: from about 0 mol % to about 4.8 mol %;
SrO: from about 0 mol % to about 0.5 mol %;
BaO: from about 0 mol % to about 0.5 mol %; and
SnO₂: from about 0.01 mol % to about 0.11 mol %.

In one or more embodiments, the glass substrate comprises, in mol %, ranges of the following oxides:

SiO₂: from about 65.8 mol % to about 78.2 mol %;
Al₂O₃: from about 2.9 mol % to about 12.1 mol %;
B₂O₃: from about 0 mol % to about 11.2 mol %;
Li₂O: from about 0 mol % to about 2 mol %;
Na₂O: from about 3.5 mol % to about 13.3 mol %;
K₂O: from about 0 mol % to about 4.8 mol %;
ZnO: from about 0 mol % to about 3 mol %;
MgO: from about 0 mol % to about 8.7 mol %;
CaO: from about 0 mol % to about 4.2 mol %;
SrO: from about 0 mol % to about 6.2 mol %;
BaO: from about 0 mol % to about 4.3 mol %; and
SnO₂: from about 0.07 mol % to about 0.11 mol %.

In one or more embodiments, the glass substrate comprises, in mol %, ranges of the following oxides:

SiO₂: from about 66 mol % to about 78 mol %;
Al₂O₃: from about 4 mol % to about 11 mol %;
B₂O₃: from about 40 mol % to about 11 mol %;
Li₂O: from about 0 mol % to about 2 mol %;
Na₂O: from about 4 mol % to about 12 mol %;
K₂O: from about 0 mol % to about 2 mol %;
ZnO: from about 0 mol % to about 2 mol %;
MgO: from about 0 mol % to about 5 mol %;
CaO: from about 0 mol % to about 2 mol %;
SrO: from about 0 mol % to about 5 mol %;
BaO: from about 0 mol % to about 2 mol %; and
SnO₂: from about 0.07 mol % to about 0.11 mol %.

In one or more embodiments, the glass substrate comprising the compositions provided herein has a color shift of less than 0.008 or less than 0.005 as measured by a colorimeter. In one or more embodiments, the compositions provided herein are characterized by RₓO/Al₂O₃ being in a range of from 0.95 to 3.23, where x=2 and R is any one or more of Li, Na, K, Rb, and Cs. In one or more embodiments, R is any one of Zn, Mg, Ca, Sr or Ba, x=1 and RₓO/Al₂O₃ is in a range of from 0.95 to 3.23. In one or more embodiments, R is any one or more of Li, Na, K, Rb and Cs, x=2 and RₓO/Al₂O₃ is in a range of from 1.18 to 5.68. In one or more embodiments, R is any one or more of Zn, Mg, Ca, SR or Ba, x=1 and RₓO/Al₂O₃ is in a range of from 1.18 to 5.68. Suitable specific compositions for glass substrates according to one or more embodiments are described in International Publication Number WO2017/070066.

In one or more embodiments, glass substrates contain some alkali constituents, e.g., the glass substrates are not alkali-free glasses. As used herein, an “alkali-free glass” is a glass having a total alkali concentration which is less than or equal to 0.1 mole percent, where the total alkali concentration is the sum of the Na₂O, K₂O, and Li₂O concentrations. In some embodiments, the glass comprises Li₂O in the range of about 0 to about 3.0 mol %, in the range of about 0 to about 2.0 mol %, or in the range of about 0 to about 1.0 mol %, and all subranges therebetween. In other embodiments, the glass is substantially free of Li₂O. In other embodiments, the glass comprises Na₂O in the range of about 0 mol % to about 10 mol %, in the range of about 0 mol % to about 9.28 mol %, in the range of about 0 to about 5 mol %, in the range of about 0 to about 3 mol %, or in the range of about 0 to about 0.5 mol %, and all subranges therebetween. In other embodiments, the glass is substantially free of Na₂O. In some embodiments, the glass comprises K₂O in the range of about 0 to about 12.0 mol %, in the range of about 8 to about 11 mol %, in the range of about 0.58 to about 10.58 mol %, and all subranges therebetween.

The glass substrate in some embodiments is a high-transmission glass, such as a high-transmission aluminosilicate glass. In certain embodiments, the light guide plate exhibits a transmittance normal to the at least one major surface greater than 90% over a wavelength range from 400 nm to 700 nm. For instance, the light guide plate exhibits greater than about 91% transmittance normal to the at least one major surface, greater than about 92% transmittance normal to the at least one major surface, greater than about 93% transmittance normal to the at least one major surface, greater than about 94% transmittance normal to the at least one major surface, or greater than about 95% transmittance normal to the at least one major surface, over a wavelength range from 400 nm to 700 nm, including all ranges and subranges therebetween.

In certain embodiments, the edge surface of the glass substrate that is configured to receive light from a light source scatters light within an angle less than 12.8 degrees full width half maximum (FWHM) in transmission. In some embodiments, the edge surface is configured to receive light from a light source is processed by grinding the edge without polishing, or by other methods for processing LGPs known to those or ordinary skill in the art, as disclosed in U.S. Published Application No. 2015/0368146, hereby incorporated by reference in its entirety. Alternatively, the LGP can be provided with a score/break edge with minimal chamfer.

The glass substrate of some embodiments is chemically strengthened, e.g., by ion exchange. During the ion exchange process, ions within a glass at or near the surface of the glass can be exchanged for larger metal ions, for example, from a salt bath. The incorporation of the larger ions into the glass can strengthen the glass by creating a compressive stress in a near surface region. A corresponding tensile stress can be induced within a central region of the glass to balance the compressive stress.

According to certain embodiments, the organosilicate film is applied to the glass substrate as a standalone (i.e., single) layer, and additional layers are not applied or deposited on the glass substrate. Alternatively, the organosilicate film is included on the glass substrate along with additional layers that are provided below, and/or above the organosilicate film (e.g., as part of a multi-layer or stacked film).

The organosilicate film according to some embodiments is compatible with existing glass compositions, and therefore, does not require changing the bulk glass composition to reduce weathering-based issues in LGPs. In addition, in some embodiments, the organosilicate film improves adhesion of light extraction features and lenses to the substrate, and satisfactory surface energetics, modulus and density, which can be tuned to improve adhesion with the substrate.

Certain embodiments of the disclosure are directed to processing methods comprising exposing a glass substrate to a silicon-containing precursor and a co-reactant to form a flowable film.

In one embodiment, the silicon-containing precursor is a silane. As used herein, silanes refer to saturated compounds consisting of one or multiple silicon atoms linked to each other or other chemical elements, with the one or more silicon atom arranged as the tetrahedral center of multiple single bonds. Examples of silanes that can be used as a silicon-containing precursor include, but are not limited to, tetramethylsilane (TMS), trimethylsilane, dimethylsilane, methylsilane, trichlorosilane, and tetraethoxysilane. In one embodiment, the silane is selected from tetramethylsilane and trimethylsilane. In one embodiment, the silane is tetramethylsilane.

It has been found that certain long-chain organosilanes, particularly when applied to the substrate as a monolayer with non-bonding molecules being washed away with a solvent, are not as effective at reducing weathering-based light extraction. For example, dimethyloctadecyl[3-(trimethoxysilyl)propyl]ammonium chloride and Dow Corning 2634, which is an alkoxysilane that contains a PFPE polymer chain, were found, when tested in accordance with the present disclosure, to be not as effective. Accordingly, in one embodiment, long-chain organosilanes are excluded as silanes. As used herein, long-chain organosilanes refers to silanes that contain a chain of at least 10, 11, 12, 13, 14, 15, 16 or 17 atoms bound to a silicon atom.

As noted above, long-chain organosilanes are typically applied as monolayers, with removal of non-bonded molecules achieved with rinsing with an appropriate solvent. This is in contrast to condensed film structures of the organosilicate coatings through curing (e.g., introducing and curing the organosilicate film) or plasma-induced network formation (e.g., APCVD) that is found to improve the weathering characteristics of the alkali-glass. Due to this difference, organosilicate coatings that are applied, in certain embodiments, by curing or via a plasma-induced network formation, resist the propensity for de-wetting in addition to the hermetic properties that allows them to able to retain their network structure without aging-induced degradation. In contrast, when certain long-chain organosilanes are applied with a solvent rinse (and without curing or without plasma-induced network formation) it is believed that silane molecules are absorbed into the substrate, where they disadvantageously form droplet-shaped islands on the substrate due to water-induced dewetting during accelerated aging or reliability testing. Accordingly, in certain embodiments, long-chain organosilanes are excluded as silanes only when they are applied to the substrate using a method that does not involve curing or plasma-induced network formation, such as chemical vapor deposition methods.

In one embodiment, the silicon-containing precursor is a siloxane or/and silazane. As used herein, a siloxane is a compound with a Si—O—Si linkage, a silazane is a compound with Si—N—Si linkage. Examples of siloxanes that can be used as a silicon-containing precursor include, but are not limited to, octamethylcyclotetrasiloxane, 1,1,3,3-tetramethyldisiloxane, trimethylcyclotrisiloxane, hexamethyldisiloxane and tetramethylcyclotetrasiloxane. In one embodiment, the siloxane is selected from hexamethyldisiloxane and tetramethylcyclotetrasiloxane. Silazane could be selected from but not limited to hexamethyldisilazane, tetramethyldisilazane, hexamethylcyclotrisilazane , etc. In some embodiments, a precursor diethoxymethylsilane (DEMS), or tetravinyltetramethylcyclotetrasiloxane, or ethoxytrimethylsilane, etc. could be flowed with reactive gas of O₂.

In certain embodiments, the co-reactant is selected from one or more of argon, nitrogen, oxygen, nitrous oxide, ammonia and ozone. In one embodiment, the co-reactant includes oxygen. In one embodiment, the co-reactant includes ammonia.

In certain embodiments, the glass substrate can be processed in a chemical vapor deposition (CVD) chamber the silicon-containing precursor and the co-reactant can be fed to the chemical vapor deposition (CVD) chamber to form the flowable film on the glass substrate. The CVD chamber can be operated at or near atmospheric pressure (APCVD), or at low, sub-atmospheric pressure (LPCVD), or at very low (ultra-high vacuum) pressures (UHVCVC), such as below 10⁻⁶ Pa. The CVD chamber can be a plasma enhanced chemical vapor deposition chamber (PECVD). The plasma can be generated, for example, by radio frequency, alternating current, direct current, microwave, combustion, hot filament, or other techniques known to those of ordinary skill in the art. In one embodiment, the CVD chamber is operated at or near atmosphere pressure and is an APCVD chamber.

In certain embodiments, a Si-containing precursor can be introduced to a CVD chamber, and a suitable co-reactant (e.g., one or more of NH₃ or O₂) can be delivered to the chamber through, for example, a RPS (remote plasma source) which will generate plasma active species as the co-reactants. Plasma activated co-reactants (e.g., co-reactants containing radicals), in certain embodiments, have high energies and can react with Si-containing precursor molecules in the gas phase to form corresponding flowable polymers. In some embodiments, the co-reactant is generated with a plasma gas that comprises of mixtures of NH₃ and O₂, or N₂ and O₂. In some embodiments, the co-reactant is generated with a plasma gas that comprises oxygen.

In certain embodiments, the plasma can be generated or ignited within the processing chamber (e.g., a direct plasma) or can be generated outside of the processing chamber and flowed into the processing chamber (e.g., a remote plasma).

In certain embodiments, the composition of the film can be adjusted by changing the composition of the reactive gas. To form a nitrogen containing film, the co-reactant can comprise, for example, ammonia or nitrogen, nitrogen and oxygen in a mixture and mixtures of ammonia and oxygen. To form a carbon containing film, the reactive gas may comprise, for example, one or more of propylene and acetylene with or without mixing with oxygen. Those skilled in the art will understand that combinations of or other species can be included in the reactive gas mixture to modify the composition of the organosilicate film.

In certain embodiments, the organosilicate film is formed by introducing a polymerized or partially polymerized siloxane compound, optionally diluted with a solvent, onto the glass substrate, and curing the polymerized or partially polymerized siloxane compound. It is understood that the polymerized or partially polymerized siloxane compound can be introduced onto the glass substrate by a variety of methods, such as by spray-coating or dip-coating, or by spinning the polymerized or partially polymerized siloxane compound onto the substrate. As used herein, spinning includes processes (and products) in which the polymerized or partially polymerized siloxane compound is initially provided on the substrate by any means, and distributed on the substrate via a spinning or other rotational movement.

Polymerized or partially polymerized siloxane compounds that can be introduced on glass substrates are commercially available, often described as spin-on glass or SOG. For example, partially polymerized methyl silsesquioxane (e.g., Honeywell Accuglass® 512B or Honeywell Accuglass® T11 spin-on glass (available from Honeywell Electronic Materials)), partially polymerized silsesquioxane, poly-methyl silsesquioxane (HardSil™ AM, available from Gelest, Inc.), poly-phenyl-silsesquioxane, and poly-methyl-phenyl silsesquioxane (HardSil™ AP, available from Gelest, Inc.) are non-limiting examples that can be used according to embodiments of the instant disclosure in one or more embodiments. In one embodiment, the polymerized or partially polymerized siloxane compound is a polymerized or partially polymerized methyl silsesquioxane, such as, for example, Honeywell Accuglass® 512B.

The polymerized or partially polymerized siloxane compound, in certain embodiments, is diluted with a solvent prior to being introduced onto the glass substrate. In certain embodiments, the solvent can be selected from an alcohol (e.g., isopropyl alcohol or ethanol) and water. In one embodiment, the solvent is isopropyl alcohol. In embodiments employing a solvent, the polymerized or partially polymerized siloxane compound constitutes, for example, from 10 wt % to about 90 wt % of the solvent/polymerized or partially polymerized siloxane compound mixture. In one embodiment, 30 wt % Honeywell Accuglass® 512B in isopropyl alcohol is introduced onto the glass substrate.

Spin, spray, dip, slot or curtain coating can be used to apply these polymerized or partially polymerized siloxane compound onto glass substrate. Each method requires the coating solution (concentration, viscosity, surface tension) and coating parameters (spin coating: angular velocity, spray: various parameters to control droplet size, slot/dip/curtain-coating speed, slit opening etc.,) to be optimized such that the coating is applied as a thin film (nm to a few um) evenly across the surface of a substrate using the desired material in a solvent. Spray, slot or curtain coating may be more applicable for LGPs, where larger area coatings are required. In addition, glass surface has to be cleaned with appropriate cleaning method to improve the coating wettability and adhesion.

Once the organosilicate film has been introduced onto the glass substrate, the substrate is baked and cured. Solvent is completely removed by baking step followed by cure step for the partially polymerized siloxanes to complete the condensation reaction. In one or more embodiments, curing can be achieved by maintaining the substrate at an elevated temperature (e.g., from about 70° C. to about 500° C.) for an extended period of time (e.g., for about 30 min to about 240 min, optionally curing at individual stages of increasing temperature at each stage). In one embodiment, the glass substrate is cured at 80° C. for 30 minutes, then 125-150° C. for 30 minutes, and then 300-420° C. for 60 minutes. Other curing schedules can be employed by those of ordinary skill in the art. In certain embodiments, the curing takes place in a controlled environment, i.e., an environment that will prevent, or reduce the likelihood, of external contaminants from coming into contact with the glass substrate during the curing process.

In embodiments that employ a silsesquioxane (e.g., methyl silsesquioxane) as the polymerized or partially polymerized siloxane compound, the curing schedule may be selected to fully condense the silsesquioxane structure. By “condense,” it is meant that that the curing process reduces the hydrocarbon content in the film, which increases the film's density, and the cured film approaches the refractive index of silica. There is a maximum level of cure feasible for the film, which will provide a maximum density and a maximum refractive index. A film, having been cured to this maximum level so that it achieves the maximum density and refractive index is understood, for purposes of this disclosure, to be fully condensed.

The thickness of the organosilicate film according to one or more embodiments ranges from about 1 nm to about 100 nm, or from about 5 nm to about 1000 nm, or from about 1 nm to about 1200 nm, or from about 5 nm to about 1200 nm. In other embodiments, examples of suitable thicknesses include ranges of about 2.5-100 nm, about 5.0-100 nm, about 10-100 nm, about 25-100 nm, about 50-100 nm, about 75-100 nm, 2.5-200 nm, about 5.0-200 nm, about 10-200 nm, about 25-200 nm, about 50-200 nm, about 75-200 nm, 2.5-250 nm, about 5.0-250 nm, about 10-250 nm, about 25-250 nm, about 50-250 nm, about 75-250 nm, 2.5-300 nm, about 5.0-300 nm, about 10-300 nm, about 25-300 nm, about 50-300 nm, about 75-300 nm, 2.5-350 nm, about 5.0-350 nm, about 10-350 nm, about 25-350 nm, about 50-350 nm, about 75-350 nm, 2.5-400 nm, about 5.0-400 nm, about 10-400 nm, about 25-400 nm, about 50-400 nm, about 75-400 nm, 2.5-5500 nm, about 5.0-500 nm, about 10-500 nm, about 25-500 nm, about 50-500 nm, about 75-500 nm, 2.5-750 nm, about 5.0-750 nm, about 10-750 nm, about 25-750 nm, about 50-750 nm, or about 75-750 nm. In one embodiment, the organosilicate film is spin-on glass film and has a thickness of from about 150 to about 250 nm, or of from about 150 to about 200 nm.

In certain embodiments, the organosilicate film has a refractive index of from about 1.1 to about 1.45, of from about 1.1 to about 1.43, of from about 1.1 to about 1.41, of from about 1.05 to about 1.45, of from about 1.05 to about 1.43, of from about 1.05 to about 1.41. In some embodiments, the lower limit of the refractive index is less than 1.05.

In certain embodiments, the organosilicate film has a water contact angle (measured by a goniometer) by of at least 70°, or at least 80°, or at least 90°, or at least 100°, or at least 110°. In certain embodiments, the organosilicate film is a hydrophobic film, and/or the organosilicate film has a water contact angle of at least 90°.

In some embodiments, the surface can be treated so that the water contact angle is less than 30°, or at least 20°, or at least 10°, for example, by using an oxygen plasma treatment to render the surface hydrophilic.

In certain embodiments, the organosilicate film has a total surface energy of less than 55 mJ/m², or less than 40 mJ/m², or less than 35 mJ/m², or less than 25 mJ/m². Surface energies, as used herein, are calculated according to the Wu model based on the contact angles (CA) of three different test liquids (de-ionized water, hexadecane (HD), and di-iodomethane (DIM)). See, S. Wu, J. Sci. C, 34, 19, 1971, hereby incorporated by reference in its entirety.

In certain embodiments, the organosilicate film has a polar surface energy component of less than about 25 mJ/m², or less than about 10 mJ/m², or less than about 5 mJ/m².

According to various embodiments, at least one major surface of the glass substrate, after deposition of the organosilicate film, can be provided with one or more of a light extraction feature (LEF) or a lenticular lens applied over the organosilicate film. For example, a plurality of light extraction features can be present on or in the surface of the substrate in any given pattern or design, which may, for example, be random or arranged, repetitive or non-repetitive, uniform or non-uniform. In other embodiments, the light extraction features may be located within the matrix of the glass substrate adjacent the surface, or alternatively, may be located within the organosilicate film, e.g., below the surface. For example, the light extraction features can be distributed across the surface, e.g., as textural features making up a roughened or raised surface, or may be distributed within and throughout the substrate or portions thereof, e.g., as laser-damaged features.

The LGP may be treated to create light extraction features according to any method known in the art, e.g., the methods disclosed in co-pending and co-owned International Patent Application Publication Nos. WO2014058748 and WO2015095288, each incorporated herein by reference in their entirety.

Various embodiments of the disclosure will now be discussed with reference to the figures, which illustrate exemplary embodiments of microstructure arrays and light guide plates. The following general description is intended to provide an overview of the claimed devices, and various aspects will be more specifically discussed throughout the disclosure with reference to the non-limiting depicted embodiments, these embodiments being interchangeable with one another within the context of the disclosure.

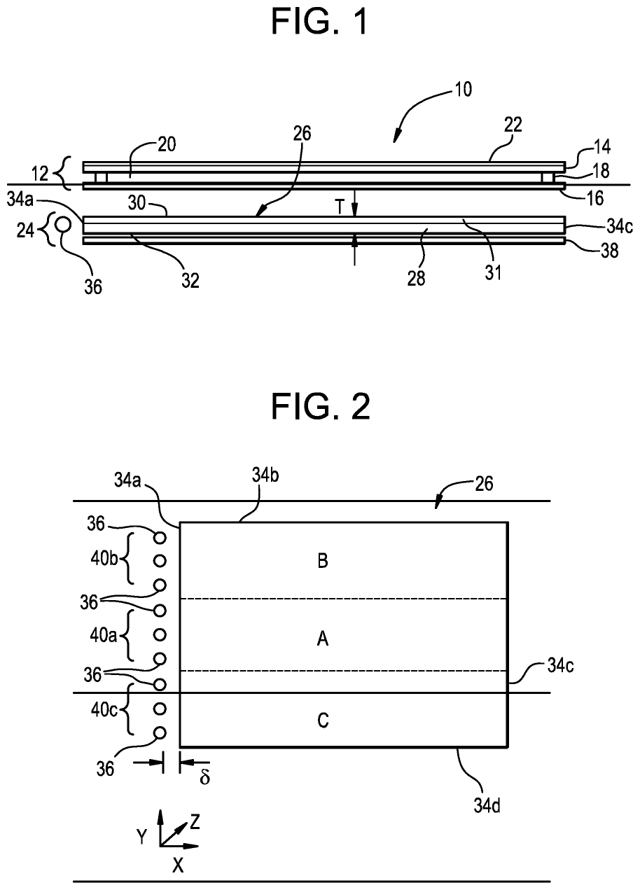

An exemplary LCD display device 10 is shown in FIG. 1 comprising an LCD display panel 12 formed from a first substrate 14 and a second substrate 16 joined by an adhesive material 18 positioned between and around a peripheral edge portion of the first and second substrates. First and second substrates 14, 16 and adhesive material 18 form a gap 20 therebetween containing liquid crystal material. Spacers (not shown) may also be used at various locations within the gap to maintain consistent spacing of the gap. First substrate 14 may include color filter material. Accordingly, first substrate 14 may be referred to as the color filter substrate. On the other hand, second substrate 16 includes thin film transistors (TFTs) for controlling the polarization state of the liquid crystal material, and may be referred to as the backplane. LCD panel 12 may further include one or more polarizing filters 22 positioned on a surface thereof.

LCD display device 10 further comprises BLU 24 arranged to illuminate LCD panel 12 from behind, i.e., from the backplane side of the LCD panel. In some embodiments, the BLU may be spaced apart from the LCD panel, although in further embodiments, the BLU may be in contact with or coupled to the LCD panel, such as with a transparent adhesive. BLU 24 comprises a glass light guide plate (LGP) 26 formed with a glass substrate 28 as the light guide having an organosilicate film 31 thereon, glass substrate 28 including a first major surface 30, a second major surface 32, and a plurality of edge surfaces extending between the first and second major surfaces. In embodiments, glass substrate 28 may be a parallelogram, for example a square or rectangle comprising four edge surfaces 34a, 34b, 34c and 34d as shown in FIG. 2 extending between the first and second major surfaces defining an X-Y plane of the glass substrate 28, as shown by the X-Y-Z coordinates. For example, edge surface 34a may be opposite edge surface 34c, and edge surface 34b may be positioned opposite edge surface 34d. Edge surface 34a may be parallel with opposing edge surface 34c, and edge surface 34b may be parallel with opposing edge surface 34d. Edge surfaces 34a and 34c may be orthogonal to edge surfaces 34b and 34d. The edge surfaces 34a-34d may be planar and orthogonal to, or substantially orthogonal (e.g., 90+/−1 degree, for example 90+/−0.1 degree) to major surfaces 30, 32, although in further embodiments, the edge surfaces may include chamfers, for example a planar center portion orthogonal to, or substantially orthogonal to major surfaces 30, 32 and joined to the first and second major surfaces by two adjacent angled surface portions.

First and/or second major surfaces 30, 32 may include an average roughness (Ra) in a range from about 0.1 nanometer (nm) to about 0.6 nm, for example less than about 0.6 nm, less than about 0.5 nm, less than about 0.4 nm, less than about 0.3 nm, less than about 0.2 nm, or less than about 0.1 nm. An average roughness (Ra) of the edge surfaces may be equal to or less than about 0.05 micrometers (μm), for example in a range from about 0.005 micrometers to about 0.05 micrometers.

The foregoing level of major surface roughness can be achieved, for example, by using a fusion draw process or a float glass process followed by polishing. Surface roughness may be measured, for example, by atomic force microscopy, white light interferometry with a commercial system such as those manufactured by Zygo, or by laser confocal microscopy with a commercial system such as those provided by Keyence. The scattering from the surface may be measured by preparing a range of samples identical except for the surface roughness, and then measuring the internal transmittance of each. The difference in internal transmission between samples is attributable to the scattering loss induced by the roughened surface. Edge roughness can be achieved by grinding and/or polishing.

Glass substrate 28 further comprises a maximum glass substrate thickness t in a direction orthogonal to first major surface 30 and second major surface 32. In some embodiments, glass substrate thickness t may be equal to or less than about 3 mm, for example equal to or less than about 2 mm, or equal to or less than about 1 mm, although in further embodiments, glass substrate thickness t may be in a range from about 0.1 mm to about 3 mm, for example in a range from about 0.1 mm to about 2.5 mm, in a range from about 0.3 mm to about 2.1 mm, in a range from about 0.5 mm to about 2.1 mm, in a range from about 0.6 mm to about 2.1 mm, or in a range from about 0.6 mm to about 1.1 mm, including all ranges and subranges therebetween. In some embodiments, thickness of the glass substrate can be in the range from about 0.1 mm to about 3.0 mm (e.g., from about 0.3 mm to about 3 mm, from about 0.4 mm to about 3 mm, from about 0.5 mm to about 3 mm, from about 0.55 mm to about 3 mm, from about 0.7 mm to about 3 mm, from about 1 mm to about 3 mm, from about 0.1 mm to about 2 mm, from about 0.1 mm to about 1.5 mm, from about 0.1 mm to about 1 mm, from about 0.1 mm to about 0.7 mm, from about 0.1 mm to about 0.55 mm, from about 0.1 mm to about 0.5 mm, from about 0.1 mm to about 0.4 mm, from about 0.3 mm to about 0.7 mm, or from about 0.3 mm to about 0.55 mm).

In accordance with embodiments described herein, BLU 24 further comprises an array of light emitting diodes (LEDs) 36 arranged along at least one edge surface (a light injection edge surface) of glass substrate 28, for example edge surface 34a. It should be noted that while the embodiment depicted in FIG. 1 shows a single edge surface 34a injected with light, the claimed subject matter should not be so limited, as any one or several of the edges of an exemplary glass substrate 28 can be injected with light. For example, in some embodiments, the edge surface 34a and its opposing edge surface 34c can both be injected with light. Additional embodiments may inject light at edge surface 34b and its opposing edge surface 34d rather than, or in addition to, the edge surface 34a and/or its opposing edge surface 34c. The light injection surface(s) may be configured to scatter light within an angle less than 12.8 degrees full width half maximum (FWHM) in transmission.

In some embodiments, LEDs 36 may be located a distance δ from the light injection edge surface, e.g., edge surface 34a, of less than about 0.5 mm. According to one or more embodiments, LEDs 36 may comprise a thickness or height that is less than or equal to thickness t of glass substrate 28 to provide efficient light coupling into the glass substrate.

Light emitted by the array of LEDs is injected through the at least one edge surface 34a and guided through the glass substrate by total internal reflection, and extracted to illuminate LCD panel 12, for example by extraction features on one or both major surfaces 30, 32 of glass substrate 28. Such extraction features disrupt the total internal reflection, and cause light propagating within glass substrate 28 to be directed out of the glass substrate through one or both of major surfaces 30, 32. Accordingly, BLU 24 may further include a reflector plate 38 positioned behind glass substrate 28, opposite LCD panel 12, to redirect light extracted from the back side of the glass substrate, e.g., major surface 32, to a forward direction (toward LCD panel 12). Suitable light extraction features can include a roughed surface on the glass substrate, produced either by roughening a surface of the glass substrate directly, or by coating the sheet with a suitable coating, for example a diffusion film. Light extraction features in some embodiments can be obtained, for example, by printing reflective discrete regions (e.g., white dots) with a suitable ink, such as a UV-curable ink and drying and/or curing the ink. In some embodiments, combinations of the foregoing extraction features may be used, or other extraction features as are known in the art may be employed.

BLU may further include one or more films or coatings (not shown) deposited on a major surface of the glass substrate, for example a quantum dot film, a diffusing film, and reflective polarizing film, or a combination thereof.

Local dimming, e.g., one dimensional (1D) dimming, can be accomplished by turning on selected LEDs 36 illuminating a first region along the at least one edge surface 34a of glass substrate 28, while other LEDs 36 illuminating adjacent regions are turned off. Conversely, 1D local dimming can be accomplished by turning off selected LEDs illuminating the first region, while LEDs illuminating adjacent regions are turned on.

FIG. 2 shows a portion of an exemplary LGP 26 comprising a first sub-array 40a of LEDs arranged along edge surface 34a of glass substrate 28, a second sub-array 40b of LEDs arranged along edge surface 34a of glass substrate 28, and a third sub-array 40c of LEDs 36 arranged along edge surface 34a of glass substrate 28. Three distinct regions of the glass substrate illuminated by the three sub-arrays are labeled A, B and C, wherein the A region is the middle region, and the B and C regions are adjacent the A region. Regions A, B and C are illuminated by LED sub-arrays 40a, 40b and 40c, respectively. With the LEDs of sub-array 40a in the “on” state and all other LEDs of other sub-arrays, for example the sub-arrays 40b and 40c, in the “off” state, a local dimming index LDI can be defined as 1−(average luminosity of the B, C regions)/(luminosity of the A region). A fuller explanation of determining LDI can be found, for example, in “Local Dimming Design and Optimization for Edge-Type LED Backlight Unit”: Jung, et al., SID 2011 Digest, 2011, pp. 1430-1432, the content of which is incorporated herein by reference in its entirety.

It should be noted that the number of LEDs within any one array or sub-array, or even the number of sub-arrays, is at least a function of the size of the display device, and that the number of LEDs depicted in FIG. 2 are for illustration only and not intended as limiting. Accordingly, each sub-array can include a single LED, or more than one LED, or a plurality of sub-arrays can be provided in a number as necessary to illuminate a particular LCD panel, such as three sub-arrays, four sub-arrays, five sub-arrays, and so forth. For example, a typical 1D local dimming-capable 55″ (139.7 cm) LCD TV may have 8 to 12 zones. The zone width is typically in a range from about 100 mm to about 150 mm, although in some embodiments the zone width can be smaller. The zone length is about the same as a length of glass substrate 28.

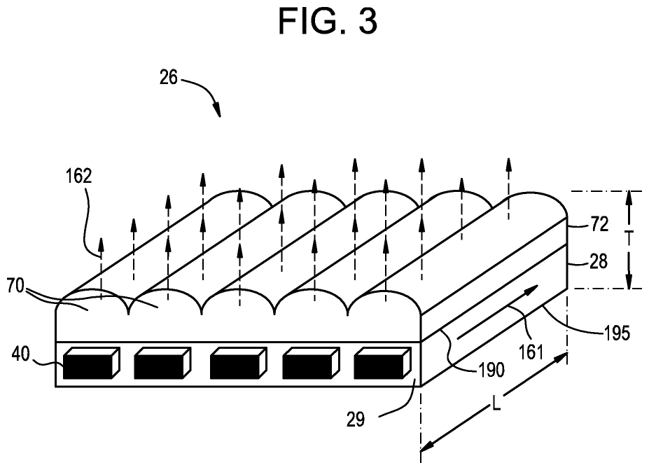

Referring now to FIG. 3, a light guide plate 26 is shown including at least one light source 40 that can be optically coupled to an edge surface 29 of the glass substrate 28, e.g., positioned adjacent to the edge surface 29. As used herein, the term “optically coupled” is intended to denote that a light source is positioned at an edge of the LGP so as to introduce light into the LGP. A light source may be optically coupled to the LGP even though it is not in physical contact with the LGP. Additional light sources (not illustrated) may also be optically coupled to other edge surfaces of the LGP, such as adjacent or opposing edge surfaces.

Light injected into the LGP from a light source 40 may propagate along a length L of the LGP as indicated by arrow 161 due to total internal reflection (TIR), until it strikes an interface at an angle of incidence that is less than the critical angle. TIR is the phenomenon by which light propagating in a first material (e.g., glass, plastic, etc.) comprising a first refractive index can be totally reflected at the interface with a second material (e.g., air, etc.) comprising a second refractive index lower than the first refractive index. TIR can be explained using Snell's law:

n₁ sin(θᵢ)=n₂ sin(θᵣ) (1),

which describes the refraction of light at an interface between two materials of differing indices of refraction. In accordance with Snell's law, n₁ is the refractive index of a first material, n₂ is the refractive index of a second material, θᵢ is the angle of the light incident at the interface relative to a normal to the interface (incident angle), and θᵣ is the angle of refraction of the refracted light relative to the normal. When the angle of refraction (θᵣ) is 90°, e.g., sin(θᵣ)=1, Snell's law can be expressed as:

$${θ}_{c} = {θ}_{i} = {sin}^{- 1} ( \frac{{n}_{2}}{{n}_{1}} ) \qquad ( 2 )$$

The incident angle θᵢ under these conditions may also be referred to as the critical angle θ_{c}. Light having an incident angle greater than the critical angle (θᵢ>θ_{c}) will be totally internally reflected within the first material, whereas light with an incident angle equal to or less than the critical angle (θᵢ≤θ_{c}) will be mostly transmitted by the first material.

In the case of an exemplary interface between air (n₁=1) and glass (n₂=1.5), the critical angle (θ_{c}) can be calculated as 41°. Thus, if light propagating in the glass strikes the air-glass interface at an incident angle greater than 41°, all the incident light will be reflected from the interface at an angle equal to the incident angle. If the reflected light encounters a second interface comprising an identical refractive index relationship as the first interface, the light incident on the second interface will again be reflected at a reflection angle equal to the incident angle.

In some embodiments, a polymeric platform 72 may be disposed on a major surface of the glass substrate 28, such as light emitting surface 190, opposite second major surface 195. The array of microstructures 70 may, along with other optical films (e.g., a reflector film and one or more diffuser films, not shown) disposed on surfaces 190 and 195 of the LGP, direct the transmission of light in a forward direction (e.g., toward a user), as indicated by the dashed arrows 162. In some embodiments, light source 40 may be a Lambertian light source, such as a light emitting diode (LED). Light from the LEDs may spread quickly within the LGP, which can make it challenging to effect local dimming (e.g., by turning off one or more LEDs). However, by providing one or more microstructures on a surface of the LGP that are elongated in the direction of light propagation (as indicated by the arrow 161 in FIG. 3), it may be possible to limit the spreading of light such that each LED source effectively illuminates only a narrow strip of the LGP. The illuminated strip may extend, for example, from the point of origin at the LED to a similar end point on the opposing edge. As such, using various microstructure configurations, it may be possible to effect one dimensional (1D) local dimming of at least a portion of the LGP in a relatively efficient manner.

### EXAMPLES

Various embodiments will be further clarified by the following non-limiting Examples.

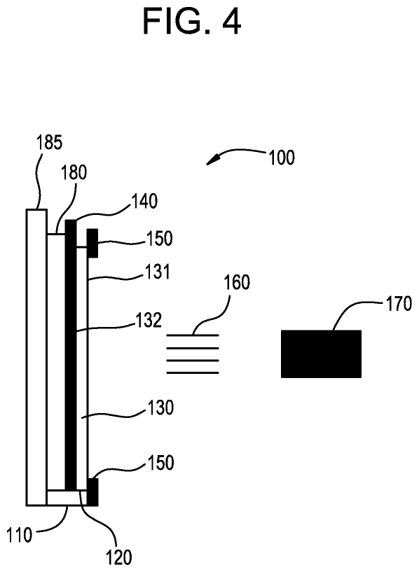

The luminance measurement apparatus 100 in the form of a simulated display product for the Examples below is shown in FIG. 4. The experimental set-up uses a BackLight Unit (BLU) extracted from a TV which has an edge-lit LED panel 110 on the bottom comprised of multiple LEDs. The LED panel 110 is optically coupled to edge surface 120 of a light guide plate 130 to launch light into the light guide plate 130. The light guide plate has a thickness of 1.1 mm defined by first major surface 131 and second major surface 132.

The luminance set-up analyzes changes in brightness of the light guide plate 30 provided with the bottom-lit LED panel 110 and reflector 140 that is provided on the “back” or “B” side of the glass substrate to bounce the extracted light from the B-side to the camera. A mask 150 to reduce light leakage reduces the extent of blooming due to the LED panel 110 and allows for a representative value for luminance in the middle of the sample.

The normal incident light from the lateral surfaces is captured by a charge coupled device (CCD) colorimeter 170 (Radiant ProMetric® Imaging Colorimeter) which outputs the luminance metric in nits within a prescribed area. The luminance measurement apparatus 100 only captures normal incident light 160 due to the lack of polymer films typically used in the back-light unit (BLU) in televisions. The set-up is further optimized by using a mask (a sheet of material having a black perimeter around a 150 mm×500 mm×1.1 mm substrate, the mask extending 10 mm from the edges of the substrate) and a 1.5 mm thick spacer 180 on the metal TV back frame 185 to reduce edge-bloom based luminance artifacts.

The luminance data analysis is conducted with edge exclusion zone of 20% from the edge of the mask, where the average luminance and standard deviation of the luminance of the sample is measured. This contrasts with the industry-standard 9-point measurement which does not completely capture the heterogeneity of the white spot formation. With sufficient sampling, appropriate data handling and analytical procedures, the change in luminance (in nits) for an aged sample due to white spots is measured against a reference (for example, unaged sample) that provides a baseline luminance value (in nits).

The particle analysis is conducted using optical microscopy in dark-field mode with the appropriate magnification to observe the white spots. With sufficient sampling, appropriate data handling and analytical procedures, metrics were obtained that directly affect and/or correlate luminance of the LGP, for example, particle density per unit area (for example, per square millimeter) and/or coverage of the surface with white spots (in percentage).

### Example 1

The glass substrates were cleaned by an alkaline wash and then introduced to an APCVD chamber and subjected to the coating schedules described below. The glass substrate is this Example contained about 70-80 mol % SiO₂, about 5-10 mol % Al₂O₃, about 2-7 mol % MgO and about 10-15 mol % NaO.

The following coating schedules for the glass substrate were investigated:
1) TMS at 25 sccm and oxygen at 130 sccm (TMS 25),
2) TMS at 35 sccm and oxygen at 130 sccm (TMS 35), and
3) TMS at 45 sccm and oxygen at 130 sccm (TMS 45).

The substrate was maintained at 100° C. in an atmospheric pressure CVD apparatus with a linear plasma head about 2 mm above the substrate. The coating thicknesses ranged from 75 to 100 nm, as measured by TEM (transmission electron microscopy) and HR-SEM (high resolution scanning electron microscopy). A total of 15 parts of the coating sample were analyzed, where 3 parts each were used as luminance controls (unaged) and 60° C., 90% RH weathered surfaces at 96 h, 240 h, 580 h and 960 h. The parts were analyzed for extraneous light extraction (luminance test) due to weathering using the apparatus shown in FIG. 4 and for the size of any weathering features present (particle analysis) The parts were also chemically analyzed by XPS (x-ray photoelectron spectroscopy) for composition and sodium diffusion profile within the aged films.

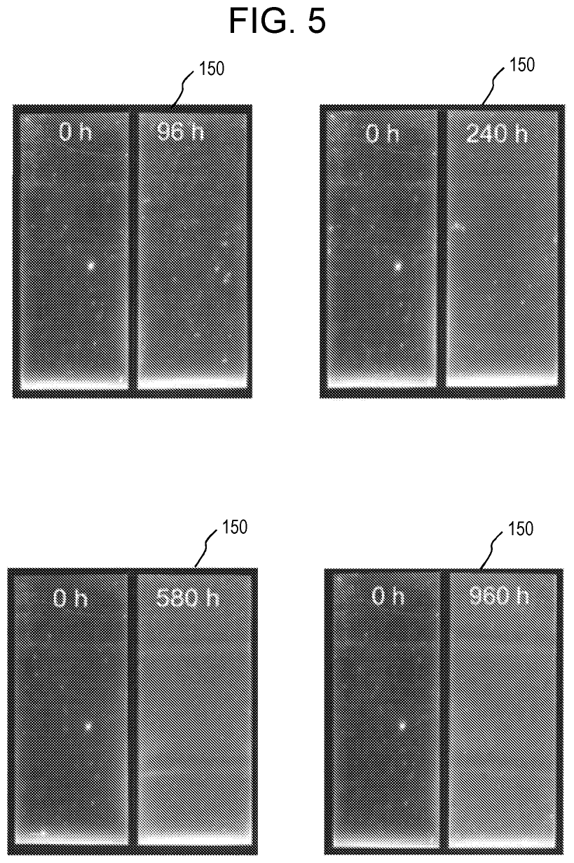

The change in light extraction for untreated glass substrate when exposed to elevated temperatures and humidity is shown in FIG. 5, in which a bottom-lit LED was introduced to the glass substrate as shown in FIG. 4. FIG. 5 depicts the aged glass substrate becoming progressively hazier upon being weathered at 96 hours, 240 hours, 580 hours and 960 hours at 60° C. and 90% relative humidity, as compared to the unaged glass substrate.

While not being bound by any particular theory, the haze observed with edge-lighting is attributed to the formation of sodium-based weathering products that range in size from sub-micron through tens of microns and behave as additional, unintended light extraction features that grow as a function of time. Optical modeling has been used to confirm the quantitative impact of these weathering-based LEFs on TV performance, in terms of change in panel brightness as a function of scattering features formed upon aging. Extraneous light extraction has been shown to increase by a factor of 8 at 960 hours at locations near the presence of weathering products.

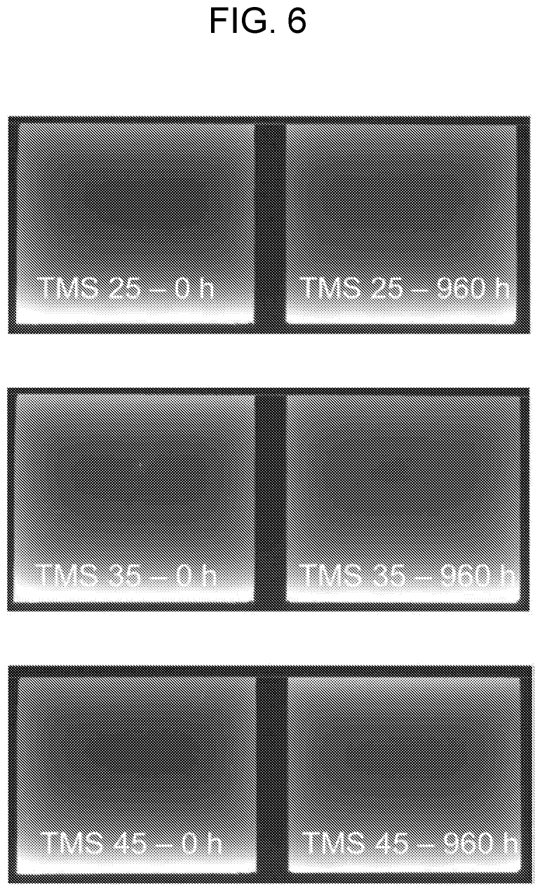

FIG. 6 provides a visual representation of the extraneous light extraction in view of any weathering products formed on aged glass substrate (50.8 mm by 50.8 mm by 1.1 mm) that is provided with an organosilicate film of about 100 nm thickness, as compared to unaged organosilicate film surfaces. As shown in the photographs depicted in FIG. 6, and in stark contrast to FIG. 5, no observable difference is detected in the luminance of unaged and aged glass substrates provided with APCVD coatings (i.e., TMS 25, 35, 45, as identified above).

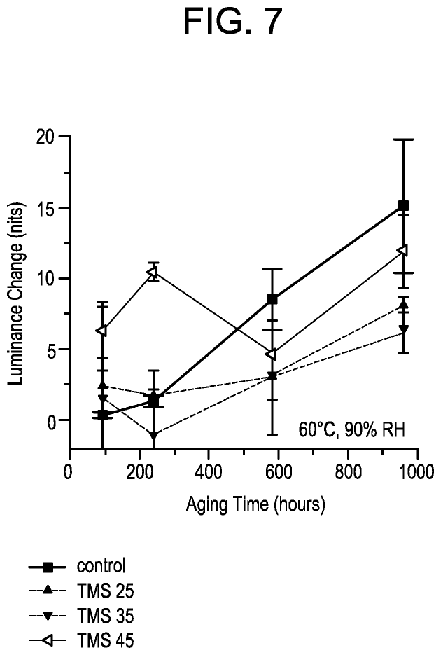

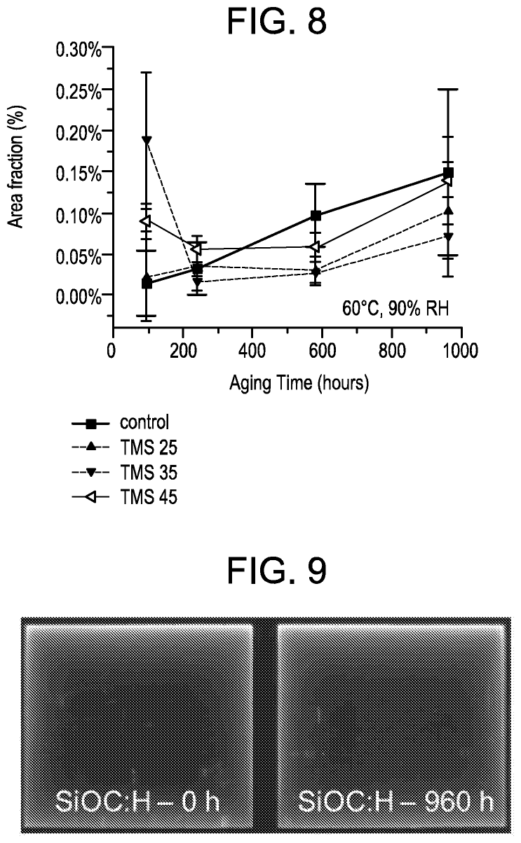

FIG. 7 graphically depicts the change in luminance of unmodified glass substrate (control) and for TMS 25, TMS 35, TMS 45 upon weathering at 60° C. and 90% relative humidity between 96 and 960 hours. FIG. 8 graphically depicts the percent coverage of these glass surfaces with weathering products (“white spots”) upon being weathered at 60° C. and 90% relative humidity between 96 and 960 hours, obtained via particle analysis. This again demonstrates that APCVD organosilicate films impart an improvement by reducing weathering product based extraneous light extraction due to the lower luminance values. In addition, no loss of film integrity or delamination with aging is observed with optical microscopy.

Table 1, below, sets forth the average elemental composition (atomic %) and chemical state of carbon of TMS 25, 35, 45 upon weathering at 60° C. and 90% relative humidity at 0 and 960 hours, as obtained via x-ray photoelectron spectroscopy (XPS) from three analysis regions away from the edge of the sample to provide an analysis of the top 5-7 nm of the film.

| | | | Na | | O | Si | C |
|---|---|---|---|---|---|---|---|
| TMS 25 | 0 | h | 0.3 | | 52.9 | 32.4 | 14.2 |
| | 960 | h | 0.8 | | 51.9 | 33.7 | 13.6 |
| TMS 35 | 0 | h | 0.2 | | 39.9 | 30.1 | 29.8 |
| | 960 | h | 0.4 | | 39.8 | 30.2 | 29.6 |
| TMS 45 | 0 | h | 0.2 | | 35.9 | 29.5 | 34.5 |
| | 960 | h | 0.2 | | 33.8 | 28.8 | 37.2 |
| | | | | | | | C—C/((C-O) + |
| | | | C—C | C—O | C═O | COO | COO) |
| TMS 25 | 0 | h | 11.8 | 1.6 | 0.6 | 0.2 | 4.9 |
| | 960 | h | 11.9 | 1.0 | 0.3 | 0.3 | 7.0 |
| TMS 35 | 0 | h | 27.8 | 1.4 | 0.3 | 0.2 | 14.6 |
| | 960 | h | 27.3 | 1.6 | 0.4 | 0.4 | 11.5 |
| TMS 45 | 0 | h | 32.5 | 1.5 | 0.4 | 0.1 | 16.3 |
| | 960 | h | 35.3 | 1.4 | 0.3 | 0.2 | 18.7 |

| | | | O/Si | O/C | C/Si |
|---|---|---|---|---|---|
| TMS 25 | 0 | h | 1.6 | 3.7 | 0.4 |
| | 960 | h | 1.5 | 3.8 | 0.4 |
| TMS 35 | 0 | h | 1.3 | 1.3 | 1.0 |
| | 960 | h | 1.3 | 1.3 | 1.0 |
| TMS 45 | 0 | h | 1.2 | 1.0 | 1.2 |
| | 960 | h | 1.2 | 0.9 | 1.3 |

As demonstrated in this Example, each of TMS 25, TMS 35, and TMS 45 resulted in the mitigation of the alkali content extracted to the outer surface upon aging that can facilitate formation of weathering products. It should be noted that the alkali diffusion mitigation does not need to be perfect for a reduction of weathering product formation and improvement in reliability attributes connected to that phenomenon.

### Example 2

The glass substrates were cleaned by an alkaline wash and 30 wt % Honeywell Accuglass® 512B Spin-On Glass in isopropyl alcohol was spun onto the glass according to the following schedule: 500 RPM for 5 seconds+3000 RPM for 30 seconds, followed by a cure schedule of 80° C. for 30 minutes+150° C. for 30 minutes+420° C. for 60 minutes. The curing schedule was selected to fully condense the silsesquioxane structure. The coating thickness was approximately 200 nm, as measured by TEM (transmission electron microscope) and HR-SEM (High Resolution scanning electron microscope).

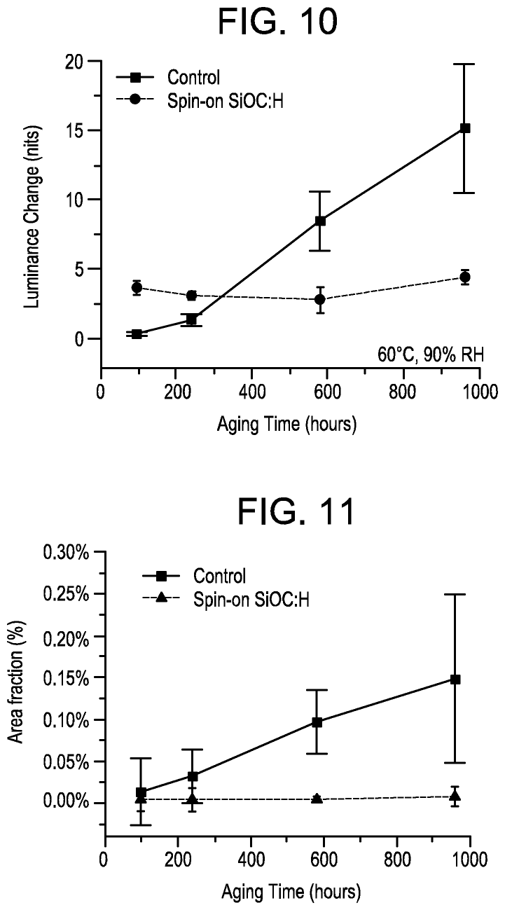

This sample is denoted below as “Spin-on SiOC:H,” and it, along with an uncoated glass substrate (“Control”) was weathered in a high temperature, high humidity environment (60° C., 90% RH) for about 1000 hours. More particularly, a total of 15 parts coating schedule were treated, where 3 parts each were used as luminance controls at 0 h and 60° C., 90% RH weathered surfaces at 96 h, 240 h, 580 h and 960h. The parts were analyzed for light extraction (luminance test) and particle analysis (weathering product based features), as described in Example 1. The parts were also chemically analyzed by XPS for composition and sodium diffusion profile within the aged films, again as described above in Example 1. Reference is made to FIG. 5 and the change in light extraction for untreated glass substrate when exposed to elevated temperatures and humidity. In contrast, no observable difference is detected in the luminance of unaged and aged spin-on glass coatings, as seen in FIG. 9. Furthermore, the luminance results in FIG. 10 and the reduced coverage of the glass surface with scattering features (“white spots”), obtained via particle analysis, shown in FIG. 11 demonstrate that spin-on glass organosilicate film alleviates weathering-product based extraneous light extraction. The luminance values of the aged spin-on glass coatings are lower than the unmodified form of the same substrate. In addition, luminance values and coverage of particulates through aging of the films remains unchanged. In addition, no loss of film integrity or delamination with aging is observed with optical microscopy.

Table 2, below, sets forth the average elemental composition (atomic %) and chemical state of carbon of Spin-on SiOC:H upon weathering at 60° C. and 90% relative humidity at 0 and 960 hours, as obtained via x-ray photoelectron spectroscopy (XPS)) from three analysis regions away from the edge of the sample to provide an analysis of the top 5-7 nm of the film.

| | | Na | O | Si | C |
|---|---|---|---|---|---|
| Spin-on | 0 h | 0.0 | 52.3 | 28.3 | 19.3 |
| SiOC:H | 960 h | 0.0 | 52.4 | 27.6 | 20.0 |
| | | C—C | C—O | C═O | COO |
| Spin-on | 0 h | 17.8 | 1.4 | 0 | 0 |
| SiOC:H | 960 h | 18.5 | 1.5 | 0 | 0 |

| | | O/Si | O/C | C/Si |
|---|---|---|---|---|
| Spin-on | 0 h | 1.9 | 2.7 | 0.7 |
| SiOC:H | 960 h | 1.9 | 2.6 | 0.7 |

As demonstrated in this Example, the spin-on glass films are shown to result in the complete mitigation of the alkali content extracted to the outer surface upon aging that can facilitate formation of weathering products (within the detection resolution of the technique). It is again noted that the alkali diffusion mitigation does not need to be perfect for a reduction of weathering product formation and improvement in reliability attributes connected to that phenomenon. The spin-on glass coating presents an alkali-deficient top surface (and film bulk), which reduces weathering-based corrosion mechanisms on high-alkali and -alkaline earth containing glasses with elevated levels of modifiers attached to non-bridging oxygens (source for extracted alkalis within the glass structure) by the mitigation of alkali diffusion.

What is claimed is:

1. A light guide plate, comprising:
a glass substrate including at least two major surfaces defining a thickness and an edge surface configured to receive light from a light source and the glass substrate configured to distribute the light from the light source; and
an organosilicate film disposed on one of the at least two major surfaces, wherein the organosilicate film reduces formation of white spots upon aging at 60° C. and 90% relative humidity for 960 hours compared to a light guide plate that does not comprise an organosilicate film.

2. The light guide plate of claim 1, wherein the light guide plate exhibits a transmittance normal to the major surface with the organosilicate film greater than 90% over a wavelength range from 400 nm to 700 nm.

3. The light guide plate of claim 2, wherein the organosilicate film is a single layer, the glass substrate not having additional layers.

4. The light guide plate of claim 2, wherein one or more of a light extraction feature (LEF) or a lenticular lens is applied over the organosilicate film.

5. The light guide plate of claim 2, wherein the glass substrate is selected from the group consisting of aluminosilicate glass, borosilicate glass, and soda-lime glass.

6. The light guide plate of claim 2, wherein the glass substrate comprises, on a mol % oxide basis:
50-90 mol % SiO₂,
0-20 mol % Al₂O₃,
0-20 mol % B₂O₃, and
0-25 mol % RₓO,
wherein x is 2 and R is chosen from Li, Na, K, Rb, Cs, and combinations thereof, or wherein x is 1 and R is chosen from Zn, Mg, Ca, Sr, Ba, and combinations thereof, and wherein the glass substrate comprises at least 0.5 mol % of one oxide selected from Li₂O, Na₂O, K₂O, CaO and MgO.

7. The light guide plate of claim 6, wherein the glass substrate comprises, on a mol % oxide basis at least 3.5 mol % of one oxide selected from Na₂O, and K₂O.

8. The light guide plate of claim 2, wherein the organosilicate film has a thickness of from about 1 nm to about 1200 nm.

9. The light guide plate of claim 2, wherein the organosilicate film is a spray-coated film.

10. The light guide plate of claim 2, wherein the organosilicate film is a dip-coated film.

11. The light guide plate of claim 2, wherein the organosilicate film is a spin-on glass-formed film.

12. The light guide plate of claim 2, wherein the organosilicate film is a chemical vapor deposition-formed film.

13. The light guide plate of claim 2, wherein the organosilicate film exhibits one or more of:
(a) a refractive index in the range of from about 1.05 to about 1.45;
(b) a water contact angle of at least of at least about 70°;
(c) a total surface energy of less than about 55 mJ/m²; or
(d) a polar surface energy component of less than about 25 mJ/m².

14. The light guide plate of claim 1, wherein the organosilicate film reduces formation of white spots upon aging at 60° C. and 90% relative humidity for 960 hours compared to a light guide plate that does not comprise an organosilicate film.

15. A display product comprising:
a light source;
a reflector; and
the light guide plate of claim 1.

16. The display product of claim 15, wherein the light source is a light emitting diode (LED) optically coupled to the edge surface of the glass substrate.

17. A method of processing a glass substrate for use as a light guide plate, the method comprising:
providing a glass substrate comprising at least two major surfaces defining a thickness and an edge surface; and
forming an organosilicate film on at least one of the at least two major surfaces;
wherein weathering-based, non-uniformity in brightness in the light guide plate arising from formation of alkali salts on the major surface with the organosilicate film is reduced, compared to a glass substrate that does not comprise the organosilicate film.

18. The method of claim 17, wherein the organosilicate film reduces or prevents formation of white spots on the light guide plate.

19. The method of claim 17, wherein forming the organosilicate film comprises introducing a flow of a silicon-containing precursor and a flow of a co-reactant to deposit the organosilicate film on the glass substrate.

20. The method of claim 19, wherein the silicon-containing precursor and the co-reactant are introduced to a Chemical Vapor Deposition (CVD) chamber.

21. The method of claim 20, wherein the silicon-containing precursor and the co-reactant are introduced into the Chemical Vapor Deposition (CVD) chamber at or near atmospheric pressure.

22. The method of claim 20, wherein the silicon-containing precursor includes one or more of a silane or a siloxane or silazane and the co-reactant includes one or more of oxygen, a mixture of ammonia and oxygen, or a mixture of nitrogen and oxygen.

23. The method of claim 22, wherein the silane is selected from tetramethylsilane, trimethylsilane and tetramethyldisilazane.

24. The method of claim 22, wherein the siloxane is selected from hexamethyldisiloxane, tetramethylcyclotetrasiloxane and hexamethyldisilazane.

25. The method of claim 17, wherein forming the organosilicate film comprises:
optionally, cleaning the glass substrate with an alkaline wash;
introducing a polymerized or partially polymerized siloxane compound, optionally with a solvent, onto the glass substrate; and
curing the polymerized or partially polymerized siloxane compound.

26. The method of claim 25, wherein polymerized or partially polymerized methyl silsesquioxane and isopropyl alcohol is introduced onto the glass substrate.

27. The method of claim 25, wherein the polymerized or partially polymerized siloxane compound is cured at a temperature and a time sufficient to fully condense a silsesquioxane structure of the polymerized or partially polymerized methyl silsequioxane.

28. The method of claim 25, wherein the polymerized or partially polymerized siloxane compound is spun onto the glass substrate.

29. The method of claim 25, wherein the polymerized or partially polymerized siloxane is dip-coated onto the glass substrate.

30. The method of claim 25, wherein the polymerized or partially polymerized siloxane is spray-coated onto the glass substrate.
